(19) United States
(12) Patent Application Publication
(10) Pub. No.: US 2005/0196152 A1
(43) Pub. Date: Sep. 8, 2005

(54) Portable videodisc player hanging structure

(75) Inventors: Ching-Jou Chen, Taipei City (TW); Tzu-Wei Lai, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/857,901

(22) Filed: Jun. 2, 2004

(30) Foreign Application Priority Data
Mar. 3, 2004 (TW) 093203165

(51) Int. Cl. H04N 5/781

(52) U.S. Cl. 386/125; 386/126

(57) ABSTRACT

A portable videodisc player hanging structure is disclosed to include a portable videodisc player, which two hanging holes respectively formed in two opposite lateral sides thereof and two mounting rods respectively disposed in the hanging holes, and a hanging belt for hanging the portable videodisc player on a vehicle seat, the hanging belt having two coupling members respectively provided at the two distal ends thereon for coupling respectively to the mounting rods of the portable videodisc player, and an adjustment frame for adjusting the length of the belt body to fasten up the belt body after hanging of the belt body on the vehicle seat.

### BACKGROUND OF THE INVENTION

1. Field of the Invention

The present invention relates to a videodisc player hanging structure and more particularly, to a portable videodisc player hanging structure, which is practical for use in a motor vehicle.

2. Description of Related Art

A regular portable videodisc player generally comprises a display panel for video data output. For example, the display panel of a portable DVD (digital video disc) player can be used to display video data (movie picture) stored in a digital videodisc.

Further, it is quite common to use a family car as a transportation vehicle to the office or for travel. People may carry a portable DVD player to the inside of a car for watching a movie picture. However, it is inconvenient to hold a portable DVD player in a passenger seat inside a car. When using a portable DVD player inside a car, the portable DVD player must be firmly secured in place to prevent oscillation during movement of the car.

### SUMMARY OF THE INVENTION

The present invention has been accomplished under the circumstances in view. It is therefore the main object of the present invention to provide a portable videodisc player hanging structure, which i practical in use to hang a portable videodisc player in a motor vehicle. It is another object of the present invention to provide a portable videodisc player hanging structure, which has means to secure the portable videodisc player firmly in place inside the motor vehicle, preventing oscillation of the portable videodisc player during movement of the motor vehicle.

To achieve these and other objects or the present invention, the portable videodisc player hanging structure is comprised of a portable videodisc player and a hanging belt. The portable videodisc player comprises a display screen, two opposite lateral sides, and two hanging holes respectively formed in the two opposite lateral sides. The hanging belt comprises a belt body. The belt body comprises two coupling ends and two first coupling members respectively provided at the two coupling ends for respectively fastening to the two hanging holes of the portable videodisc player. Each the first coupling member can be hook, coupling barrel, or the like.

When in use, the belt body of the hanging belt is hung on the headrest of a vehicle seat inside a motor vehicle to secure the portable videodisc player to the vehicle seat.

The hanging belt further comprises at least one adjustment frame adapted to adjust the length of the belt body. After hanging of the belt body on a vehicle seat, each adjustment frame is moved to adjust the length of the belt body and to further fasten up the belt body, preventing oscillation of the portable videodisc player during movement of the motor vehicle.

The belt body may be comprised of two parts. Each part of the belt body has the aforesaid first coupling member connectable to the portable videodisc player, and a second end, each second end provided with a second coupling member, which can be a hook or coupling barrel for fastening to the vehicle seat.

### BRIEF DESCRIPTION OF THE DRAWINGS

FIG. 1 is a perspective view of a portable videodisc player hanging structure according to the first embodiment of the present invention.

FIG. 2 is a perspective view of a portable videodisc player hanging structure according to the second embodiment of the present invention.

FIG. 3 is an applied view of the second embodiment of the present invention, showing the portable videodisc player hanging structure fastened to a vehicle seat.

FIG. 4 is a perspective view of a portable videodisc player hanging structure according to the third embodiment of the present invention.

### DETAILED DESCRIPTION OF THE PREFERRED EMBODIMENT

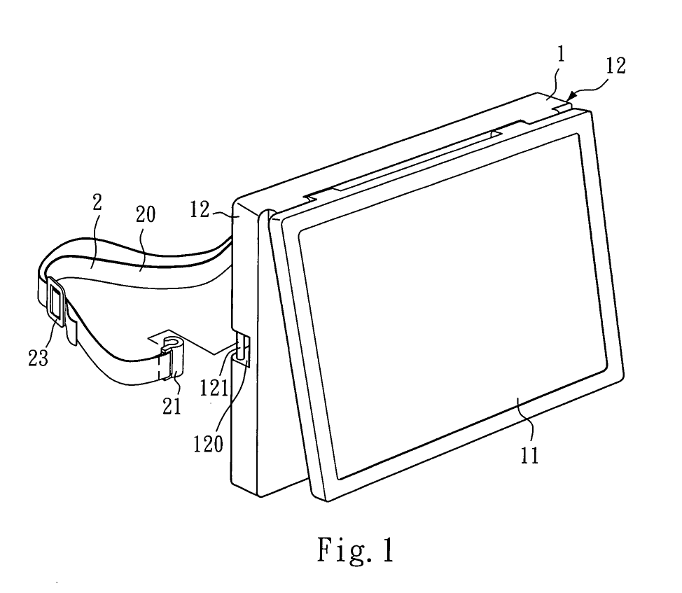

Referring to FIG. 1, a portable videodisc player hanging structure in accordance with the first embodiment of the present invention is shown comprised of a portable videodisc player 1, and a hanging belt 2. The portable videodisc player 1 comprises a display screen 11, two opposite lateral sides 12, two hanging holes 120 respectively formed in the two opposite lateral sides 12, and two mounting rods 121 respectively disposed in the hanging holes 120.

The hanging belt 2 comprises a belt body 20, two first coupling members 21 respectively provided at the two distal ends of the belt body 20. The two first coupling members 21 are hooks, also the two first coupling members 21 can be coupling barrels, or the like. By means of fastening the two first coupling members 21 to the mounting rods 121 at the two opposite lateral sides 12 of the portable videodisc player 1 respectively, the hanging belt 2 and the portable videodisc player 1 are fastened together.

Further, the hanging belt 2 comprises an adjustment frame 23 adapted to adjust the length of the belt body 20.

When in use, the belt body 20 of the hanging belt 2 is hung on the headrest of the seat inside a motor vehicle to hold the portable videodisc player 1 on the back side of the seat. After hanging of the belt body 20 on the seat, the adjustment frame 23 is moved to adjust the length of the belt body 20 and to further fasten the belt body 20 to the seat firmly, preventing oscillation of the portable videodisc player 1 upon movement of the motor vehicle.

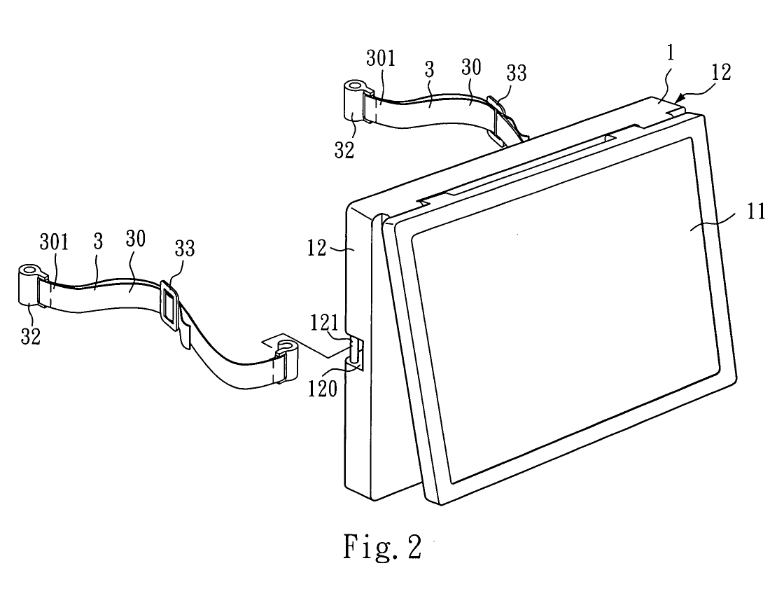

FIG. 2 illustrates a portable videodisc player hanging structure according to the second embodiment of the present invention. According to this embodiment, the portable videodisc player hanging structure is comprised of a portable videodisc player 1, and a hanging belt 3. The portable videodisc player 1 is same as that shown in FIG. 1. The belt body 30 of the hanging belt 3 is comprised of two parts 301. The two parts 301 each have one end respectively detachably connectable to the mounting rods 121 at the two opposite lateral sides 12 of the portable videodisc player 1 (in the same manner as the aforesaid first embodiment), and the other end provided with a respective second coupling member 32, for example, a coupling barrel. Further each part 301 is provided with a respective adjustment frame 33, which is adapted to adjust the length of the respective part 301.

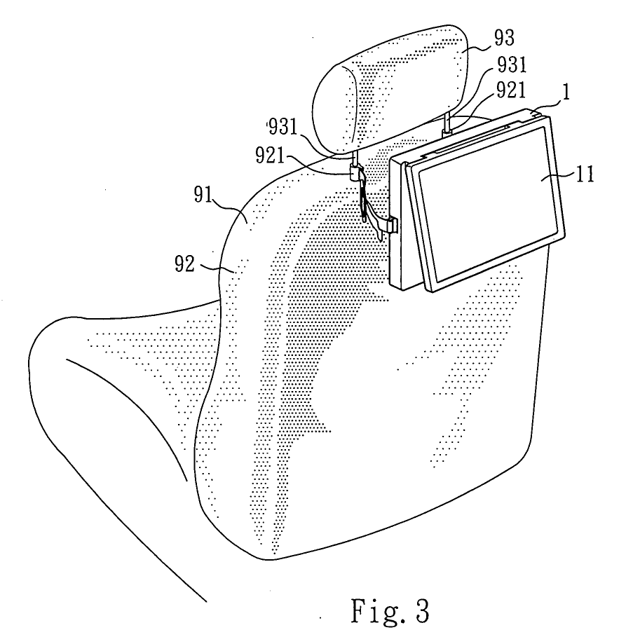

As illustrated in FIG. 3, the vehicle seat 91 comprises a back 92, which has two top insertion holes 921, and a headrest 93, which comprises two bottom mounting rods 931 respectively inserted into the insertion holes 921.

During installation, the two second coupling members (coupling barrels) 32 of the two parts 301 of the belt body 3 are respectively coupled to (sleeved onto) the bottom mounting rods 931 of the headrest 93, and then the bottom mounting rods 931 of the headrest 93 are respectively inserted into the two top insertion holes 921 to secure the portable videodisc player 1 to the vehicle seat 91, and then each adjustment frame 33 is moved to adjust the length of the respective part 301 of the belt body 30 so as to secure the portable videodisc player 1 to the back 92 of the vehicle seat 91 firmly in place.

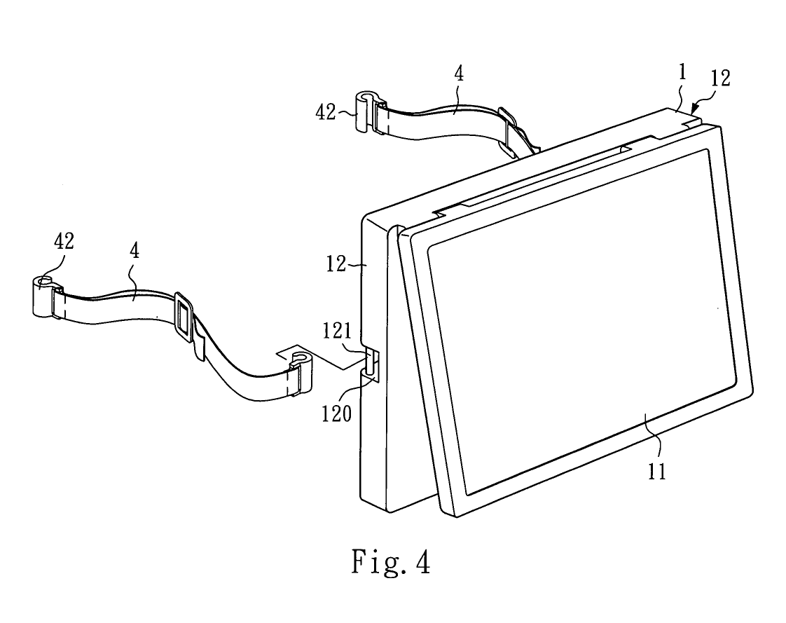

FIG. 4 illustrates a portable videodisc player hanging structure according to the third embodiment of the present invention. This embodiment is substantially similar to the aforesaid second embodiment with the exception that the second coupling member 42 at the distal end of each of the two parts of the belt body of the hanging belt 4 is a hook.

Although the present invention has been explained in relation to its preferred embodiments, it is to be understood that many other possible modifications and variations can be made without departing from the spirit and scope of the invention as hereinafter claimed.

1. A portable videodisc player hanging structure comprising:
a portable videodisc player, said portable videodisc player comprising a display screen, two opposite lateral sides, and two hanging holes respectively formed in said two opposite lateral sides; and
a hanging belt adapted to hang said portable videodisc player on a vehicle seat, said hanging belt comprising a belt body, said belt body comprising two coupling ends and two first coupling members respectively provided at said two coupling ends for respectively fastening to said two hanging holes of said portable videodisc player, each said first coupling member being selected from the group of coupling members of hook and coupling barrel.

2. The portable videodisc player hanging structure as claimed in claim 1, wherein said portable videodisc player further comprises two hanging rods respectively disposed in said two hanging holes for the mounting of the two first coupling members of said hanging belt.

3. The portable videodisc player hanging structure as claimed in claim 1, wherein said hanging belt further comprises at least one adjustment frame adapted to adjust the length of said belt body.

4. The portable videodisc player hanging structure as claimed in claim 1, wherein said belt body is comprised of two parts, each said part having said first coupling member connectable to said portable videodisc player, and a second end, each said second end being provided with a second coupling member selected from the group of coupling members of hook and coupling barrel for fastening to said vehicle seat.
